(19) United States
(12) Patent Application Publication
(10) Pub. No.: US 2024/0296840 A1
(43) Pub. Date: Sep. 5, 2024

(54) Text Injection For Training Auxiliary Tasks In Speech Recognition Models

(71) Applicant: Google LLC, Mountain View, CA (US)

(72) Inventors: Shaan Jagdeep Patrick Bijwadia, San Francisco, CA (US); Shuo-yiin Chang, Sunnyvale, CA (US); Tara N. Sainath, Jersey City, NJ (US); Weiran Wang, San Jose, CA (US); Zhong Meng, Mountain View, CA (US)

(73) Assignee: Google LLC, Mountain View, CA (US)

(21) Appl. No.: 18/592,590

(22) Filed: Mar. 1, 2024

Related U.S. Application Data
(60) Provisional application No. 63/487,686, filed on Mar. 1, 2023.

(51) Int. Cl. G10L 15/197; G10L 15/02; G10L 15/06

(52) U.S. Cl. CPC G10L 15/197; G10L 15/02; G10L 15/063

(57) ABSTRACT

A joint auxiliary task and ASR model includes an encoder to receive a sequence of acoustic frames and generate, at each of a plurality of output steps, a higher-order feature representation for a corresponding acoustic frame. The model also includes a multi-output HAT decoder to generate at each of the plurality of output steps a probability distribution over possible speech recognition hypotheses, and an indication of whether the output step corresponds to an auxiliary token associated with a particular auxiliary task. The model is trained by a JEIT training process based on: a paired training data set including paired audio data and transcriptions, the transcriptions annotated with ground-truth auxiliary tokens associated with the particular auxiliary task; and an unpaired training data set including textual utterances not paired with any corresponding audio data, the textual utterances annotated with the ground-truth auxiliary tokens associated with the particular auxiliary task.

### CROSS REFERENCE TO RELATED APPLICATIONS

This U.S. patent application claims priority under 35 U.S.C. § 119(e) to U.S. Provisional Patent Application No. 63/487,686, filed on Mar. 1, 2023. The disclosure of this prior application is considered part of the disclosure of this application and is hereby incorporated by reference in its entirety.

### TECHNICAL FIELD

This disclosure relates to text injection for training auxiliary tasks in speech recognition models.

### BACKGROUND

Automatic speech recognition (ASR) is the process of transcribing input audio into text. ASR is an increasingly important technology that may be used to enable a user SUMMARY

One aspect of the disclosure provides a joint auxiliary task and automated speech recognition (ASR) model. The joint auxiliary and ASR model includes an encoder configured to receive, as input, a sequence of acoustic frames characterizing one or more utterances, and generate, at each output step of a plurality of output steps, a higher-order feature representation for a corresponding acoustic frame in the sequence of acoustic frames. The joint auxiliary and ASR model also includes a multi-output hybrid autoregressive transducer (HAT) decoder configured to receive, as input, a sequence of non-blank symbols output by a final Softmax layer, and receive, as input, the higher-order feature representation generated by the encoder at each output step of the plurality of output steps. The multi-output HAD decoder is also configured to generate, at each output step of the plurality of output steps: a probability distribution over possible speech recognition hypotheses, and an indication of whether the output step corresponds to an auxiliary token associated with a particular auxiliary task. The joint auxiliary task and ASR model is trained by a joint end-to-end model and internal language model training process based on: a paired training data set including a first set of training samples, each training sample in the first set of training samples including audio data characterizing an utterance of speech paired with a corresponding transcription of the utterance, the corresponding transcription annotated with ground-truth auxiliary tokens associated with the particular auxiliary task; and an unpaired training data set including a second set of training samples, each training sample in the second set of training samples including a textual utterance not paired with any corresponding audio data, the textual utterance annotated with the ground-truth auxiliary tokens associated with the particular auxiliary task.

Implementations of the disclosure may include one or more of the following optional features. In some implementations, one or more of the corresponding transcriptions in the paired training data set are annotated with the ground-truth auxiliary tokens automatically based on a set of heuristic-based rules and exceptions applied to the corresponding transcriptions and corresponding portions of the paired audio data. Additionally or alternatively, one or more of the corresponding transcriptions in the paired training data set are annotated with the ground-truth auxiliary tokens via distillation from a language model teacher that receives the corresponding transcriptions as input and injects the ground-truth auxiliary tokens into the corresponding transcriptions. Additionally or alternatively, one or more of the textual utterances in the unpaired training data set are annotated with the ground-truth auxiliary tokens via distillation from a language model teacher that receives the textual utterances as input and injects the ground-truth auxiliary tokens into the textual utterances. In some examples, one or more of the textual utterances in the unpaired training data set each include text characterizing a short query, and each textual utterance of the one or more of the textual utterances in the unpaired training data set that includes text characterizing a short query are annotated with the ground-truth auxiliary tokens by appending a first type of ground-truth auxiliary token at an end of the textual utterance.

In some implementations, the multi-output HAT decoder includes a prediction network configured to, at each output step of the plurality of output steps receive, as input, the sequence of non-blank symbols output by a final Softmax layer, and generate a hidden representation. The multi-output HAT decoder also includes a first joint network configured to receive, as input, the hidden representation generated by the prediction network at each output step of the plurality of output steps and the higher-order feature representation generated by the encoder at each output step of the plurality of output steps, and generate, at each output step of the plurality of output steps, the probability distribution over possible speech recognition hypotheses. The multi-output HAT decoder further includes a second joint network configured to receive, as input, the hidden representation generated by the prediction network at each output step of the plurality of output steps and the higher-order feature representation generated by the encoder at each output step of the plurality of output steps, and generate, at each output step of the plurality of output steps, the indication of whether the output step corresponds to the auxiliary token.

In some examples, at each output step of the plurality of output steps, the sequence of previous non-blank symbols received as input at the prediction network includes a sequence of N previous non-blank symbols output by the final Softmax layer, and the prediction network is configured to generate the hidden representation by: for each non-blank symbol of the sequence of N previous non-blank symbols, generating a respective embedding; and generating an average embedding by averaging the respective embeddings, the average embedding including the hidden representation. In some implementations, the auxiliary token includes a first type of auxiliary token, and the multi-output HAT decoder further includes a third joint network configured to: receive, as input, the hidden representation generated by the prediction network at each output step of the plurality of output steps and the higher-order feature representation generated by the encoder at each output step of the plurality of output steps; and generate, at each output step of the plurality of output steps, another indication of whether the output step corresponds to a second type of auxiliary token associated with a second auxiliary task that is different from the particular auxiliary task.

In some implementations, the auxiliary token associated with the particular auxiliary task includes one of a pause token associated with the particular auxiliary task of pause prediction, an end of speech token associated with the particular auxiliary task of pause prediction, or a capitalization token associated with the particular auxiliary task of punctuation. In some examples, the auxiliary token includes a first type of auxiliary token associated with the particular auxiliary task; the multi-output HAT decoder is further configured to generate, at each output step of the plurality of output steps, another indication of whether the output steps corresponds to a second type of auxiliary token associated with a second auxiliary task that is different from the particular auxiliary task; and the second type of auxiliary token associated with the second auxiliary task includes a different one of the pause token, the end of speech token, or the capitalization token.

Another aspect of the disclosure provides a computer-implemented method executed on data processing hardware that causes the data processing hardware to perform operations including receiving a sequence of acoustic frames characterizing one or more utterances. At each of a plurality of output steps, the operations include generating, by an encoder of a joint auxiliary task and automated speech recognition (ASR) model, a higher-order feature representation for a corresponding acoustic frame in the sequence of acoustic frames. At each of the plurality of the output steps, the operations also include generating, by a multi-output hybrid autoregressive transducer (HAT) decoder of the joint auxiliary task and ASR model, based on the higher-order feature representation generated by the encoder at the corresponding output step and a sequence of non-blank symbols output by a final Softmax layer: a probability distribution over possible speech recognition hypotheses; and an indication of whether the output step corresponds to an auxiliary token associated with a particular auxiliary task. The joint auxiliary task and ASR model is trained by a joint end-to-end model and internal language model training process based on: a paired training data set including a first set of training samples, each training sample in the first set of training samples including audio data characterizing an utterance of speech paired with a corresponding transcription of the utterance, the corresponding transcription annotated with ground-truth auxiliary tokens associated with the particular auxiliary task; and an unpaired training data set including a second set of training samples, each training sample in the second set of training samples including a textual utterance not paired with any corresponding audio data, the textual utterance annotated with the ground-truth auxiliary tokens associated with the particular auxiliary task.

Implementations of the disclosure may include one or more of the following optional features. In some implementations, one or more of the corresponding transcriptions in the paired training data set are annotated with the ground-truth auxiliary tokens automatically based on a set of heuristic-based rules and exceptions applied to the corresponding transcriptions and corresponding portions of the paired audio data. Additionally or alternatively, one or more of the corresponding transcriptions in the paired training data set are annotated with the ground-truth auxiliary tokens via distillation from a language model teacher that receives the corresponding transcriptions as input and injects the ground-truth auxiliary tokens into the corresponding transcriptions. Additionally or alternatively, one or more of the textual utterances in the unpaired training data set are annotated with the ground-truth auxiliary tokens via distillation from a language model teacher that receives the textual utterances as input and injects the ground-truth auxiliary tokens into the textual utterances. In some examples, one or more of the textual utterances in the unpaired training data set each include text characterizing a short query, and each textual utterance of the one or more of the textual utterances in the unpaired training data set that includes text characterizing a short query are annotated with the ground-truth auxiliary tokens by appending a first type of ground-truth auxiliary token at an end of the textual utterance.

In some implementations, the multi-output HAT decoder includes a prediction network configured to, at each output step of the plurality of output steps receive, as input, the sequence of non-blank symbols output by a final Softmax layer, and generate a hidden representation. The multi-output HAT decoder also includes a first joint network configured to receive, as input, the hidden representation generated by the prediction network at each output step of the plurality of output steps and the higher-order feature representation generated by the encoder at each output step of the plurality of output steps, and generate, at each output step of the plurality of output steps, the probability distribution over possible speech recognition hypotheses. The multi-output HAT decoder further includes a second joint network configured to receive, as input, the hidden representation generated by the prediction network at each output step of the plurality of output steps and the higher-order feature representation generated by the encoder at each output step of the plurality of output steps, and generate, at each output step of the plurality of output steps, the indication of whether the output step corresponds to the auxiliary token.

In some examples, at each output step of the plurality of output steps, the sequence of previous non-blank symbols received as input at the prediction network includes a sequence of N previous non-blank symbols output by the final Softmax layer, and the prediction network is configured to generate the hidden representation by: for each non-blank symbol of the sequence of N previous non-blank symbols, generating a respective embedding; and generating an average embedding by averaging the respective embeddings, the average embedding including the hidden representation. In some implementations, the auxiliary token includes a first type of auxiliary token, and the multi-output HAT decoder further includes a third joint network configured to: receive, as input, the hidden representation generated by the prediction network at each output step of the plurality of output steps and the higher-order feature representation generated by the encoder at each output step of the plurality of output steps; and generate, at each output step of the plurality of output steps, another indication of whether the output step corresponds to a second type of auxiliary token associated with a second auxiliary task that is different from the particular auxiliary task.

In some implementations, the auxiliary token associated with the particular auxiliary task includes one of a pause token associated with the particular auxiliary task of pause prediction, an end of speech token associated with the particular auxiliary task of pause prediction, or a capitalization token associated with the particular auxiliary task of punctuation. In some examples, the auxiliary token includes a first type of auxiliary token associated with the particular auxiliary task; the multi-output HAT decoder is further configured to generate, at each output step of the plurality of output steps, another indication of whether the output steps corresponds to a second type of auxiliary token associated with a second auxiliary task that is different from the particular auxiliary task; and the second type of auxiliary token associated with the second auxiliary task includes a different one of the pause token, the end of speech token, or the capitalization token.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example speech recognition system.

FIG. 2 is a schematic view of an example joint auxiliary task and automatic speech recognition (ASR) model.

FIG. 3 is a schematic view of an example prediction network.

FIGS. 4A and 4B are schematic views of a two-phase training process 400 for training the ASR model 200 using text injection.

FIG. 5 is a flowchart of an example arrangement of operations for a computer-implemented method for performing auxiliary tasks in an ASR model.

FIG. 6 is a schematic view of an example computing device that may be used to implement the systems and methods described herein.

Like reference symbols in the various drawings indicate like elements.

### DETAILED DESCRIPTION

Automatic speech recognition (ASR) is the process of transcribing input audio into text. ASR is an increasingly important technology that may be used to enable a user to interact with mobile or other devices using spoken (i.e., speech-based) interactions. While ASR systems are typically evaluated based on word error rate (WER), this is not the only metric of concern for production applications in which one or more auxiliary tasks must be integrated with the ASR in a full end-to-end (E2E) system. Example auxiliary tasks include, but are not limited to, capitalization and punctuation to improve readability, voice activity detection and end-of-query detection to reduce latency, and natural conversation understanding to predict the cadence and turn-taking aspects of an ongoing conversation. Conventionally, auxiliary tasks are performed in separate models downstream of an ASR model. Auxiliary tasks have been integrated into end-to-end (E2E) ASR models. Once integrated into an E2E ASR model, however, integrated text-to-text auxiliary tasks can no longer be trained using text-only data using traditional methods. Unfortunately, text-only data is often more plentiful than paired audio-text data and not being able to train on such text-only data may limit the performance of the integrated auxiliary tasks. Accordingly, there is a need for improved methods of training auxiliary tasks in E2E ASR models.

In disclosed implementations, an E2E joint auxiliary task and ASR model is trained using text injection to provide improved training for the auxiliary tasks that are integrated into the E2E ASR model. By injecting text, disclosed implementations for training the auxiliary tasks of an E2E ASR model may benefit from both co-training of the auxiliary tasks with ASR on paired audio-text data and training using readily-available large corpuses of text-only data. Therefore, the performance of auxiliary tasks that are integrated into an E2E joint auxiliary task and ASR model can be improved, particularly for long-tail utterances.

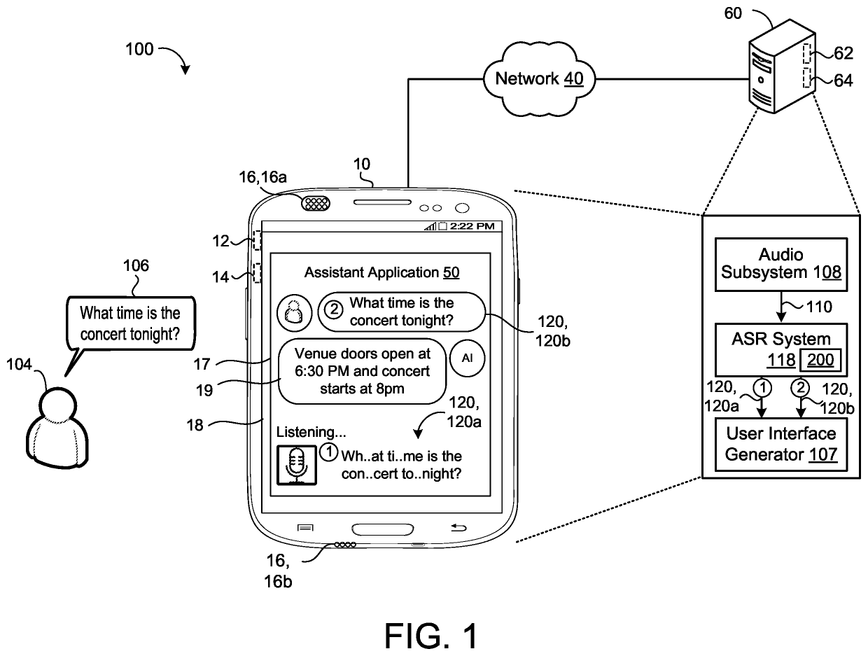

FIG. 1 is an example system 100 that includes one or more users 104 interacting with a user device 10 through voice input. The user device 10 (also referred to generally as a user device 10) is configured to capture sounds (e.g., streaming audio data) from the one or more users 104 within an environment of the system 100. Here, the streaming audio data may refer to an utterance 106 spoken by the user 104 that functions as an audible query, a command for the user device 10, or an audible communication captured by the user device 10. Speech-enabled systems of the user device 10 may field the query or the command by answering the query and/or causing the command to be performed/fulfilled by one or more downstream applications.

The user device 10 may correspond to any computing device associated with the user 104 and capable of receiving audio data. Some examples of user devices 10 include, but are not limited to, mobile devices (e.g., smart watches), smart appliances, internet of things (IoT) devices, vehicle infotainment systems, smart displays, smart speakers, etc. The user device 10 includes data processing hardware 12 and memory hardware 14 in communication with the data processing hardware 12 and stores instructions that, when executed by the data processing hardware 12, cause the data processing hardware 12 to perform one or more operations. The user device 10 further includes an audio system 16 with an audio capture device 16a (e.g., a microphone) for capturing and converting the utterances 106 into electrical signals and a speech output device 16b (e.g., a speaker) for communicating with an audible audio signal (e.g., as output data from the user device 10). The user device 10 may implement an array of audio capture devices 16a without departing from the scope of the present disclosure, whereby one or more capture devices 16a in the array may not physically reside on the user device 10, but be in communication with the audio system 16.

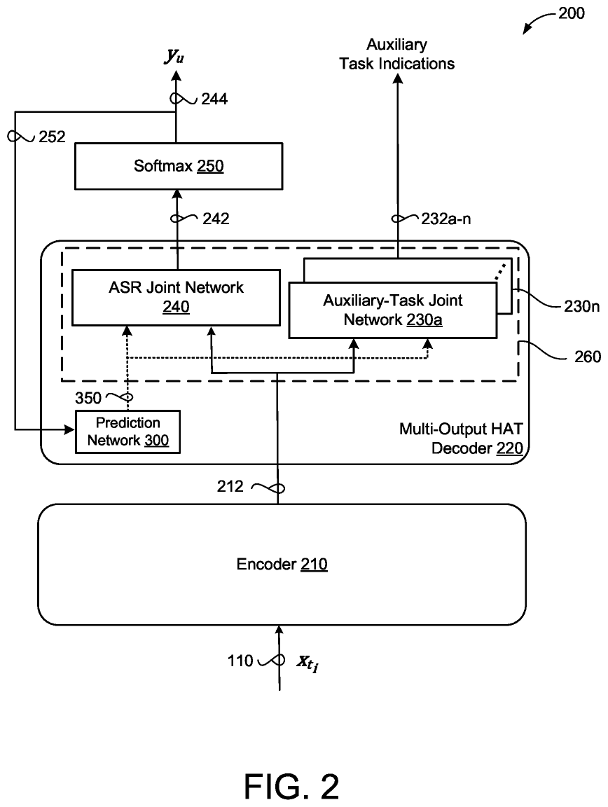

The system 100 includes an automated speech recognition (ASR) system 118 that implements a joint auxiliary task and ASR model 200 (also referred to herein as ASR model 200) and resides on the user device 10 of the user 104 and/or on a remote computing system 60 (e.g., one or more remote servers of a distributed system executing in a cloud-computing environment) in communication with the user device 10 via a network 40. As described below in connection with FIG. 2, the ASR model 200 may include one or more auxiliary-task joint networks 230, 230a-n that perform a corresponding auxiliary task in addition to an ASR joint network 240 that performs ASR. Alternatively, some or all of the auxiliary-task joint networks 230 may be integrated with the ASR joint network 240. The remote computing system 60 may include physical and/or virtual (e.g., cloud based) resources, such as data processing hardware 62 (e.g., remote servers or CPUs) and/or memory hardware 64 (e.g., remote databases or other storage hardware). The memory hardware 64 is in communication with the data processing hardware 62 and stores instructions that, when executed by the data processing hardware 62, cause the data processing hardware 62 to perform one or more operations.

The user device 10 and/or the remote computing system 60 also includes an audio subsystem 108 configured to receive the utterance 106 spoken by the user 104 and captured by the audio capture device 16a, and convert the utterance 106 into a corresponding digital format associated with input acoustic frames 110 capable of being processed by the ASR system 118. In the example shown, the user speaks a respective utterance 106 and the audio subsystem 108 converts the utterance 106 into a corresponding sequence of acoustic frames 110 for input to the ASR system 118. Thereafter, the ASR model 200 receives, as input, the sequence of acoustic frames 110 corresponding to the utterance 106, and generates/predicts, at each output step, a corresponding transcription 120 (e.g., also referred to herein as speech recognition result 120) of the utterance 106 as the ASR model 200 receives (e.g., processes) each acoustic frame 110 in the sequence of acoustic frames 110.

In the example shown, the ASR model 200 may perform streaming speech recognition to produce an initial speech recognition result 120, 120a and generate a final speech recognition result 120, 120b by improving the initial speech recognition result 120a. The speech recognition results 120 may either correspond to a partial speech recognition result or an entire speech recognition result. Stated differently, the speech recognition result 120 may either correspond to a portion of an utterance 106 or an entire utterance 106. For example, the partial speech recognition result may correspond to a portion of a spoken utterance or even a portion of a spoken term. However, as will become apparent, the ASR model 200 may perform additional processing on the final speech recognition result 120b whereby the final speech recognition result 120b may be delayed from the initial speech recognition result 120a.

The user device 10 and/or the remote computing system 60 also executes a user interface generator 107 configured to present a representation of the transcription 120 of the utterance 106 to the user 104 of the user device 10. As described in greater detail below, the user interface generator 107 may display the initial speech recognition results 120a in a streaming fashion during time 1 and subsequently display the final speech recognition results 120b in a streaming fashion during time 2. In some configurations, the transcription 120 output from the ASR system 118 is processed, e.g., by a natural language understanding (NLU) or natural language processing (NLP) module executing on the user device 10 or the remote computing system 60, to execute a user command/query specified by the utterance 106. Additionally or alternatively, a text-to-speech system (not shown) (e.g., executing on any combination of the user device 10 or the remote computing system 60) may convert the transcription 120 into synthesized speech for audible output by the user device 10 and/or another device.

In the example shown, the user 104 interacts with a digital assistant application 50 or other program of the user device 10 that uses the ASR system 118. For instance, FIG. 1 depicts the user 104 communicating with the digital assistant application 50 and the digital assistant application 50 displaying a digital assistant interface 17 on a screen 18 of the user device 10 to depict a conversation between the user 104 and the digital assistant application 50. In this example, the user 104 asks the digital assistant application 50, “What time is the concert tonight?” This question from the user 104 is a spoken utterance 106 captured by the audio capture device 16a and processed by audio subsystem 108 of the user device 10. In this example, the audio subsystem 108 receives the spoken utterance 106 and converts it into a sequence of acoustic frames 110 for input to the ASR system 118.

Continuing with the example, the ASR model 200, while receiving the sequence of acoustic frames 110 corresponding to the utterance 106 as the user 104 speaks, encodes the sequence of acoustic frames 110 and then decodes the encoded sequence of acoustic frames 110 into the initial speech recognition results 120a. During time 1, the user interface generator 107 presents, via the digital assistant interface 17, a representation of the initial speech recognition results 120a of the utterance 106 to the user 104 of the user device 10 in a streaming fashion such that words, word pieces, and/or individual characters appear on the screen as soon as they are spoken. In some examples, the first look ahead audio context is equal to zero.

During time 2, the user interface generator 107 presents, via the digital assistant interface 17, a representation of the final speech recognition results 120b of the utterance 106 to the user 104 of the user device 10 in a streaming fashion such that words, word pieces, and/or individual characters appear on the screen as soon as they are generated by the ASR model 200. In some implementations, the user interface generator 107 replaces the representation of the initial speech recognition results 120a presented at time 1 with the representation of the final speech recognition results 120b presented at time 2. Here, time 1 and time 2 may include timestamps corresponding to when the user interface generator 107 presents the respective speech recognition result 120. In this example, the timestamp of time 1 indicates that the user interface generator 107 presents the initial speech recognition results 120a at an earlier time than the final speech recognition results 120b. For instance, as the final speech recognition result 120b is presumed to be more accurate than the initial speech recognition result 120a, the final speech recognition result 120b ultimately displayed as the transcription 120 may fix any terms that may have been misrecognized in the initial speech recognition results 120a. In this example, the streaming initial speech recognition results 120a output by the ASR model 200 are displayed on the screen of the user device 10 at time 1 are associated with low latency and provide responsiveness to the user 104 that his/her query is being processed, while the final speech recognition result 120b output by the ASR model 200 and displayed on the screen at time 2 leverages an additional speech recognition model and/or a language model to improve the speech recognition quality in terms of accuracy, but at increased latency. However, since the initial speech recognition results 120a are displayed as the user speaks the utterance 106, the higher latency associated with producing, and ultimately displaying the final speech recognition results 120b is not noticeable to the user 104.

The final speech recognition result 120b is presumed to be more accurate than the initial speech recognition result 120a because the ASR model 200 determines the initial speech recognition results 120a in a streaming fashion and the final speech recognition results 120b using the prior non-blank symbols from the initial speech recognition result 120a. That is, the final speech recognition results 120b take into account the prior non-blank symbols and, thus, are presumed more accurate because the initial speech recognition results 120a do not take into account any prior non-blank symbols. Moreover, a rescorer (not shown for clarity of illustration) may update the initial speech recognition result 120a with the final speech recognition result 120b to provide the transcription via the user interface generator 107 to the user 104.

In the example shown in FIG. 1, the digital assistant application 50 may respond to the question posed by the user 104 using NLP or NLU. NLP/NLU generally refer to a process of interpreting written language (e.g., the initial speech recognition result 120a and/or the final speech recognition result 120b) and determining whether the written language prompts any action. In this example, the digital assistant application 50 uses NLP/NLU to recognize that the question 106 from the user 104 regards the user's schedule and more particularly a concert on the user's schedule. By recognizing these details with NLP/NLU, the automated assistant returns a response 19 to the user's query where the response 19 states, “Venue doors open at 6:30 PM and concert starts at 8 pm.” In some configurations, NLP/NLU occurs on the remote computing system 60 in communication with the data processing hardware 12 of the user device 10.

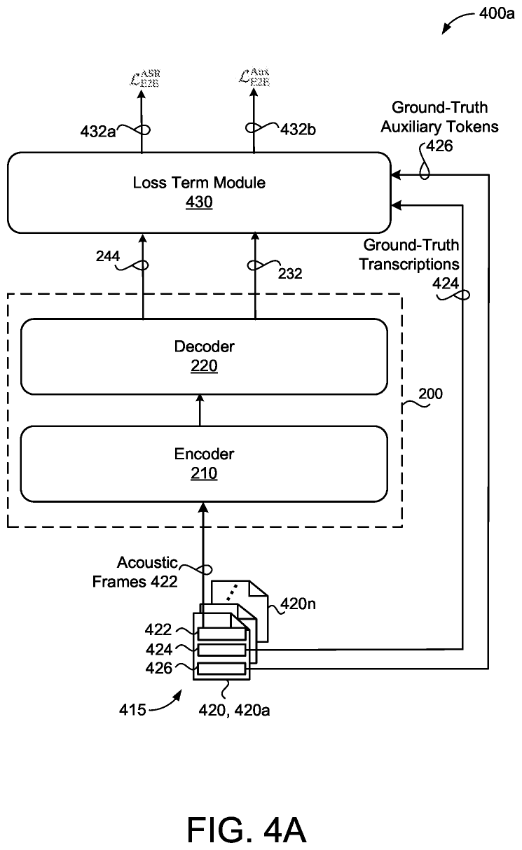

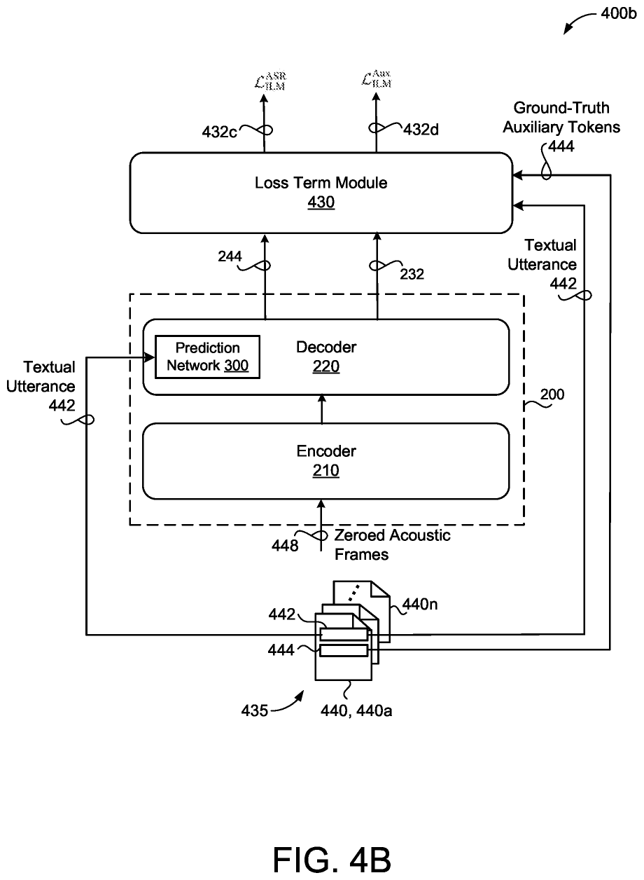

FIG. 2 depicts an example ASR model 200 that includes a Recurrent Neural Network-Transducer (RNN-T) model architecture. The use of the RNN-T model architecture is exemplary only, and the ASR model 200 may include other architectures such as transformer-transducer and conformer-transducer model architectures, among others. The RNN-T model architecture provides a small computational footprint and utilizes less memory requirements than conventional ASR architectures, making the RNN-T model architecture suitable for performing speech recognition entirely on the user device 10 (e.g., no communication with a remote computing system or server is required). An example process for training the ASR model 200 using text injection is described below in connection with FIGS. 4A and 4B.

As shown, the ASR model 200 includes an encoder 210, a multi-output hybrid autoregressive transducer (HAT) decoder 220 (also referred to herein as decoder 220), and a final Softmax layer 250 (also referred to herein as Softmax layer 250). Here, the encoder 210 and the decoder 220 collectively provide an RNN-T model. The encoder 210, which is roughly analogous to an acoustic model (AM) in a traditional ASR system, may include a recurrent network of stacked Long Short-Term Memory (LSTM) layers. Here, the encoder 210 receives a sequence of d-dimensional feature vectors (e.g., acoustic [symbol] frames 110 (FIG. 1)) x=(x₁, x₂, . . . , x_{T}), where xₜ∈ [symbol] _{d}, and generates at each output step a higher-order feature representation 212 for a corresponding acoustic frame 110 in the sequence of acoustic frames 110. This higher-order feature representation 212 is denoted as f(X)=[f₀, . . . , f_{T-1}], where fₜ= [symbol] ^{D}^{_{α}}.

In the illustrated example, the decoder 220 includes a prediction network 300, auxiliary-task joint networks 230, and an ASR joint network 240. Alternatively, some or all of the auxiliary-task joint networks 230 may be integrated with the ASR joint network 240 including, for example, integration into a single joint network 260 that implements all of the ASR joint network 240 and the auxiliary-task joint networks 230. Moreover, two or more auxiliary-task joint networks 230 may be combined. In the example shown, each auxiliary-task joint network 230 generates corresponding indications 232 of whether the current output step corresponds to an auxiliary token associated with the particular auxiliary task performed by the auxiliary-task joint network 230.

An example auxiliary-task joint network 230 performs capitalization. Here, capitalization may include restoring the correct case (uppercase or lowercase) of, for example, noisy text or text in all one case. Notably, capitalization is specific to the written domain, and has no markers in spoken speech. Capitalization may be important for maintaining readability. Another example auxiliary-task joint network 230 performs conversation turn-taking analysis. Here, conversation turn-taking analysis may include predicting when a speaker is expecting a response, versus when the speaker merely paused with the intention to resume speaking. Conversation turn-taking may also classify pauses in speech as being within a thought, or after a finished complete thought. That is, when a speaker stops speaking, the conversation turn-taking analysis predicts whether the speaker will continue speaking after a brief pause or whether the user is expecting a system response. Because the active region of interest is pauses in audio, conversation turn-taking analysis is also referred to herein as pause prediction.

The decoder 220 is configured to receive a sequence of non-blank symbols 252 output by the final Softmax layer 250, and to receive the higher-order feature representation 212 generated by the encoder 210 at each output step of the plurality of output steps. The decoder 220 generates, based on the sequence of non-blank symbols 252 and the higher-order feature representation 212, at each output step of the plurality of output steps, a probability distribution over possible speech recognition hypotheses 242, and indications 232 of whether the output step corresponds to an auxiliary token associated with a particular auxiliary task.

The prediction network 300 may include a LSTM network and, like a language model (LM), receive, as input, the sequence of non-blank symbols 252 output by the final Softmax layer 250 and generate, at each output step, a dense or hidden representation 350 (also referred to herein as representation 350). This representation 350 is denoted as g(X)=[g₀, . . . , g_{T-1}], where gₜ= [symbol] ^{D}^{ₚ}. As described in greater detail below, the representation 350 may include a single embedding vector. Notably, the sequence of non-blank symbols 252 received at a prediction network 300 captures linguistic dependencies between non-blank symbols 252 predicted during the previous output steps so far to assist the ASR joint network 240 in predicting the probability of a next output symbol or blank symbol during a current output step. As described in greater detail below, to contribute to techniques for reducing the size of the prediction network 300 without sacrificing accuracy/performance of the ASR model 200, the prediction network 300 may receive a limited-history sequence of non-blank symbols 252 y_{id-n}, . . . , yᵤᵢ₋₁ that is limited to the N previous non-blank symbols 252 output by the final Softmax layer 250.

The ASR joint network 240 combines the higher-order feature representation 212 generated by the encoder 210 and the representation 350 (e.g., a single embedding vector 350) generated by the prediction network 300. The ASR joint network 240 predicts a probability distribution 242 over the next output symbol. Stated differently, the ASR joint network 240 generates, at each output step, a respective probability distribution over possible speech recognition hypotheses 242. Here, the “possible speech recognition hypotheses” correspond to a set of output labels each representing a symbol/character in a specified natural language. For example, when the natural language is English, the set of output labels may include twenty-seven (27) symbols, e.g., one label for each of the 26-letters in the English alphabet and one label designating a space. Accordingly, the ASR joint network 240 may output a set of values indicative of the likelihood of occurrence of each of a predetermined set of output labels. This set of values can be a vector and can indicate a probability distribution over the set of output labels. In some cases, the output labels are graphemes (e.g., individual characters, and potentially punctuation and other symbols), but the set of output labels is not so limited. For example, the set of output labels can include wordpieces and/or entire words, in addition to or instead of graphemes. The probability distribution generated the ASR joint network 240 can include a posterior probability value for each of the different output labels. Thus, if there are 100 different output labels representing different graphemes or other symbols, the probability distribution generated the ASR joint network 240 can include 100 different probability values, one for each output label. The probability distribution 242 can then be used to select and assign scores to candidate orthographic elements (e.g., graphemes, wordpieces, and/or words) in a beam search process (e.g., by the Softmax layer 250) for determining the transcription 120.

In particular, the ASR joint network 240 fuses the higher-order features fₜ 212 and the representation gₜ 350 with a “project and sum” operation to produce a hidden representation h_{t,u}, which is then passed through a non-linear activation and a final linear layer to produce s_{t,u}, which may be expressed as:

$${h}_{t , u} = P \cdot {f}_{t} + Q \cdot {g}_{u} + {b}_{h} ∈ {{D}_{h}}^{} \qquad ( 1 )$$

$${s}_{t , u} = A \cdot tan h ( {h}_{t , u} ) + {b}_{s} ∈ {v}^{} \qquad ( 2 )$$

where P, Q, and A are learned weight matrices with dimensions determined by D_{α}, Dₚ, and, Dₕ, and ν is the size of the vocabulary. The 0-th logit of s_{t,u} may be used individually to compute a probability of emission b_{t,u}, which may be expressed as:

$${b}_{t , u} : = {P}_{t , u} ( < blank > \vert {f}_{0 : t} , {g}_{0 : u} ) = σ ( {s}_{t , u} [ 0 ] ) , \qquad ( 3 )$$

where σ(x)=1/(1+exp(−x)) is the sigmoid activation function. Probabilities over the ASR tokens are computing by feeding all remaining logits to a Softmax function. The probability 242 of each ASR token y_{ν} in the vocabulary may be expressed as:

$${\hat{y}}_{v ; t , u} = {P}_{t , u} ( {\hat{y}}_{v} \vert {f}_{0 : t} , {g}_{0 : u} ) = Softmax {s}_{t , u} [ 1 : ] ) [ v - 1 ] . \qquad ( 4 )$$

Thus, the predicted probability distribution 242 over all output tokens is the emission probability b_{t,u}, followed by the probabilities of each token given emission, which may be expressed as:

$${\hat{y}}_{t , u} = [ {b}_{t , u} , ( 1 - {b}_{t , u} ) \cdot {\hat{y}}_{0 ; t , u} , … , ( 1 - {b}_{t , u} ) {\hat{y}}_{V - 1 , t , u} ] . \qquad ( 5 )$$

Each of the auxiliary-task joint network 230 similarly generates, at each output step, a respective indication 232 of whether the current output step corresponds to an auxiliary token associated with a respective auxiliary task performed by the auxiliary-task joint network 230. In some implementations, an auxiliary-task joint network 230 outputs an indication 232 when the posterior probability associated with predicting an auxiliary token associated with a respective auxiliary task satisfies (e.g., is greater than) a preset or predetermined threshold. The auxiliary-task joint networks 230 can predict capitalization and pauses similarly to how the ASR joint network 240 predicts tokens. In particular, using Equation (1) and Equation (2) separately for capitalization and pauses based on the shared representations fₜ 212 and gᵤ 350. Notably, in the example shown, each auxiliary-task joint network 230 is exposed to the label history of the ASR output 252, but not its own prediction history.

Because capitalization tokens must be strictly aligned with ASR tokens, determination of the capitalization posterior reuses the blank logit from the ASR prediction. Thus, a capitalization indication 232 will only be emitted when a non-blank ASR token is emitted as well. Capitalization has an output space of y_{cap}={<cap>, <non-cap>} and its posterior may be expressed as:

$${\hat{y}}_{t , u}^{C a p} = [ {b}_{t , u}^{A S R} , ( 1 - {b}_{t , u}^{A S R} ) \cdot {P}_{t , u} ( < cap > ) , ( 1 - {b}_{t , u}^{A S R} ) \cdot {P}_{t , u} ( < non - cap > ) ] . \qquad ( 6 )$$

At inference time, P(<cap>) is estimated each time an ASR token is emitted, and capitalization is predicted when the posterior satisfies a threshold (e.g., is greater than the threshold). An example threshold is 0.5.

Pause indications do not need to be strictly aligned with ASR tokens because they are likely to be predicted during non-speech periods during inference. Thus, the pause indications may have their own blank posteriors. The pause prediction output space is yₚₐᵤₛₑ={<blank>, <non-pause>, <pause>, <eos>} and its posterior probability may be computed in the same way as capitalization tokens using Equation (5).

In some examples, the ASR model 200 embeds auxiliary tokens corresponding to the indications 232 into predicted possible speech hypotheses 244 revealed in a beam search by the softmax 250. However, when competing beams differ only in their auxiliary tokens, inserting the predicted auxiliary tokens into the speech recognition hypotheses 244 may reduce beam diversity. Accordingly, in some implementations, the ASR model 200 factorizes the predicted auxiliary tokens into parallel sequences of auxiliary tokens that are the same length as the possible speech hypotheses 244.

The final Softmax layer 250 receives the probability distribution 242 and selects the speech recognition hypothesis 244 with the highest probability to produce the transcription 120. The final Softmax layer 250 may employ any technique to select the output label/symbol with the highest probability in the distribution 242. In this manner, the decoder 220 does not make a conditional independence assumption, rather the decoder 220 conditions the prediction of each symbol yᵤ 252 not only on the acoustics but also on the sequence of labels 252 yᵤᵢ₋ₙ, . . . , yᵤᵢ₋₁ output so far. The decoder 220 does assume an output symbol 252 is independent of future acoustic frames 110, which allows the ASR model 200 to be employed in a streaming fashion.

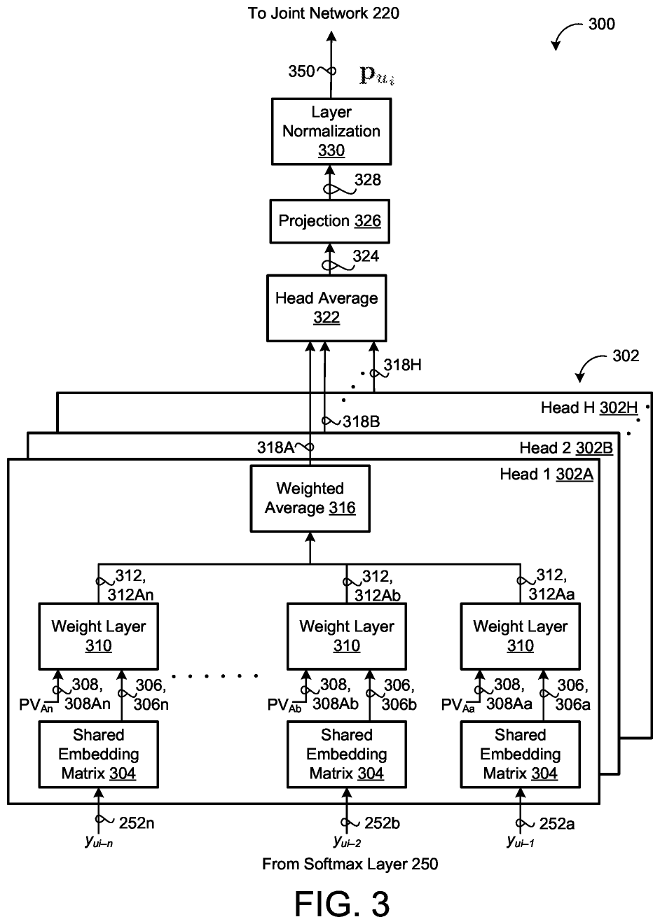

FIG. 3 is a schematic view of an example prediction network 300 for the ASR model 200. The prediction network 300 receives, as input, a sequence of non-blank symbols 252a-n yᵤᵢ₋ₙ, . . . , yᵤᵢ₋₁ that is limited to the N previous non-blank symbols 252a-n output by the final Softmax layer 250. In some examples, N is equal to two. In other examples, N is equal to five, however, the disclosure is non-limiting and N may equal any integer. The sequence of non-blank symbols 252a-n indicates an initial speech recognition result 120a (FIG. 1). In some implementations, the prediction network 300 includes a multi-headed attention mechanism 302 that shares a shared embedding matrix 304 across each head 302A-302H of the multi-headed attention mechanism. In one example, the multi-headed attention mechanism 302 includes four heads. However, any number of heads may be employed by the multi-headed attention mechanism 302. Notably, the multi-headed attention mechanism improves performance significantly with minimal increase to model size. As described in greater detail below, each head 302A-H includes its own row of position vectors 308, and rather than incurring an increase in model size by concatenating outputs 318A-H from all the heads, the outputs 318A-H are instead averaged by a head average module 322.

Referring to the first head 302A of the multi-headed attention mechanism 302, the head 302A generates, using the shared embedding matrix 304, a corresponding embedding 306, 306a-n (e.g., X∈ [symbol] ^{N×d}^{ₑ}) for each non-blank symbol among the sequence of non-blank symbols 252a-n yᵤᵢ₋ₙ, . . . , yᵤᵢ₋₁ received as input at the corresponding output step from the plurality of output steps. Notably, since the shared embedding matrix 304 is shared across all heads of the multi-headed attention mechanism 302, the other heads 302B-H all generate the same corresponding embeddings 306 for each non-blank symbol. The head 302A also assigns a respective position vector PV_{Aa-An} 308, 308Aa-An (e.g., P∈ [symbol] ^{H×N×d}^{ₑ}) to each corresponding non-blank symbol in the sequence of non-blank symbols 252a-n yᵤᵢ₋ₙ, . . . , yᵤᵢ₋₁. The respective position vector PV 308 assigned to each non-blank symbol indicates a position in the history of the sequence of non-blank symbols (e.g., the N previous non-blank symbols 252a-n output by the final Softmax layer 230). For instance, the first position vector PV_{Aa} is assigned to a most recent position in the history, while the last position vector PV_{An} is assigned to a last position in the history of the N previous non-blank symbols output by the final Softmax layer 250. Notably, each of the embeddings 306 may include a same dimensionality (i.e., dimension size) as each of the position vectors PV 308.

While the corresponding embedding generated by shared embedding matrix 304 for each for each non-blank symbol among the sequence of non-blank symbols 252a-n yᵤᵢ₋ₙ, . . . , yᵤᵢ₋₁, is the same at all of the heads 302A-H of the multi-headed attention mechanism 302, each head 302A-H defines a different set/row of position vectors 308. For instance, the first head 302A defines the row of position vectors PV_{Aa-An} 308Aa-An, the second head 302B defines a different row of position vectors PV_{Ba-Bn} 308Ba-Bn, . . . , and the H^{th} head 302 H defines another different row of position vectors PV_{Ha-Hn} 308Ha-Hn.

For each non-blank symbol in the sequence of non-blank symbols 252a-n received, the first head 302A also weights, via a weight layer 310, the corresponding embedding 306 proportional to a similarity between the corresponding embedding and the respective position vector PV 308 assigned thereto. In some examples, the similarity may include a cosine similarity (e.g., cosine distance). In the example shown, the weight layer 310 outputs a sequence of weighted embeddings 312, 312Aa-An each associated the corresponding embedding 306 weighted proportional to the respective position vector PV 308 assigned thereto. Stated differently, the weighted embeddings 312 output by the weight layer 310 for each embedding 306 may correspond to a dot product between the embedding 306 and the respective position vector PV 308. The weighted embeddings 312 may be interpreted as attending over the embeddings in proportion to how similar they are to the positioned associated with their respective position vectors PV 308. To increase computational speed, the prediction network 300 includes non-recurrent layers, and therefore, the sequence of weighted embeddings 312Aa-An are not concatenated, but instead, averaged by a weighted average module 316 to generate, as output from the first head 302A, a weighted average 318A of the weighted embeddings 312Aa-An represented by:

$$Prediction ( X , P ) = \frac{1}{H * N} {\sum }_{h , n} {X}_{n} * {\sum }_{e} ( {X}_{n , e} * {P}_{h , n , e} ) \qquad ( 7 )$$

In Equation (7), h represents the index of the heads 302, n represents position in context, and e represents the embedding dimension. Additionally, in Equation (7), H, N, and dₑ include the sizes of the corresponding dimensions. The position vector PV 308 does not have to be trainable and may include random values. Notably, even though the weighted embeddings 312 are averaged, the position vectors PV 308 can potentially save position history information, alleviating the need to provide recurrent connections at each layer of the prediction network 300.

The operations described above with respect to the first head 302A are similarly performed by each other head 302B-H of the multi-headed attention mechanism 302. Due to the different set of positioned vectors PV 308 defined by each head 302, the weight layer 310 outputs a sequence of weighted embeddings 312Ba-Bn, 312Ha-Hn at each other head 302B-H that is different than the sequence of weighted embeddings 312Aa-Aa at the first head 302A. Thereafter, the weighted average module 316 generates, as output from each other corresponding head 302B-H, a respective weighted average 318B-H of the corresponding weighted embeddings 312 of the sequence of non-blank symbols.

In the example shown, the prediction network 300 includes a head average module 322 that averages the weighted averages 318A-H output from the corresponding heads 302A-H. A projection layer 326 with SWISH may receive, as input, an output 324 from the head average module 322 that corresponds to the average of the weighted averages 318A-H, and generate, as output, a projected output 328. A final layer normalization 330 may normalize the projected output 328 to provide the single embedding vector pᵤ_{ᵢ} 350 at the corresponding output step from the plurality of output steps. The prediction network 300 generates only a single embedding vector pᵤ_{ᵢ} 350 at each of the plurality of output steps subsequent to an initial output step.

In some configurations, the prediction network 300 does not implement the multi-headed attention mechanism 302 and only performs the operations described above with respect to the first head 302A. In these configurations, the weighted average 318A of the weighted embeddings 312Aa-An is simply passed through the projection layer 326 and layer normalization 330 to provide the single embedding vector pᵤ_{ᵢ} 350.

In some implementations, to further reduce the size of the RNN-T decoder, i.e., the prediction network 300 and the joint network 222, parameter tying between the prediction network 300 and the joint network 222 is applied. Specifically, for a vocabulary size |V| and an embedding dimension dₑ, the shared embedding matrix 304 at the prediction network is E∈ [symbol] ^{|V|×d}^{ₑ}. Meanwhile, a last hidden layer includes a [symbol] dimension size dₕ at the joint network 222, feed-forward projection weights from the hidden layer to the output logits will be W∈ [symbol] ^{d}^{ₕ}^{×|V+1|}, with an extra blank token in the vocabulary. Accordingly, the feed-forward layer corresponding to the last layer of the joint network 222 includes a weight matrix [dₕ, |V]|. By having the prediction network 300 to tie the size of the embedding dimension dₑ to the dimensionality dₕ of the last hidden layer of the joint network 222, the feed-forward projection weights of the joint network 222 and the shared embedding matrix 304 of the prediction network 300 can share their weights for all non-blank symbols via a simple transpose transformation. Since the two matrices share all their values, the RNN-T decoder only needs to store the values once on memory, instead of storing two individual matrices. By setting the size of the embedding dimension dₑ equal to the size of the hidden layer dimension dₕ, the RNN-T decoder reduces a number of parameters equal to the product of the embedding dimension dₑ and the vocabulary size |V|. This weight tying corresponds to a regularization technique.

FIGS. 4A and 4B are schematic views of a two-phase training process 400 for training the ASR model 200 using text injection. The example training process 400 trains the ASR model using a JEIT (joint E2E model and internal language model (ILM)) training process. In particular, a first training phase 400a of the JEIT training process 400 (also referred to herein as training process 400) shown in FIG. 4A trains the ASR model 200 using a paired audio-text training data set, while a second training phase 400b of the training process 400 shown in FIG. 4B trains the ASR model using an unpaired training data set and text injection. Here, the first training phase 400a performs E2E training, and the second training phase 400b perform ILM training using text injection. The training process 400 trains the ASR model 200 by adjusting, adapting, updating, fine-tuning, etc. one or more parameters of the encoder 210 and the decoder 220 (i.e., weights of the weight matrices P, Q, and A of Equation (1)). The training process 400 may execute on the remote computing system 60 (i.e., on the data processing hardware 62) or on the user device 10 (i.e., on the data processing hardware 12).

In the first training phase 400a of the training process 400 shown in FIG. 4A, the ASR model 200 is trained using a paired training data set 415 that includes a first set of training samples 420, 420a-n. Each training sample 420 in the first set of training samples 420 includes audio data 422 characterizing an utterance of speech paired with a corresponding transcription 424 of the utterance. Here, the corresponding transcription 424 is annotated with one or more ground-truth auxiliary tokens 426 associated with one or more auxiliary tasks performed by the ASR model 200. In some examples, the ground-truth auxiliary-tokens 426 are inserted, for example, based on a set of heuristic-based rules and exceptions (e.g., based on force alignment) applied to the corresponding transcriptions 424 and corresponding portions of the paired audio data 422. Alternatively, the ground-truth tokens 426 may be determined via distillation from a language model teacher (e.g., a text-based “truecasting” RNN teacher model) that receives each corresponding transcription 424 as input, and determines and injects the ground-truth auxiliary tokens 426 into the corresponding transcription 424. However, the ground-truth auxiliary tokens 426 labels may be inserted using other methods, such as manually during manual transcription.

For each particular training sample 420 in the first set of training samples 420, the first training phase 400a processes, using the ASR model 200, the corresponding audio data 422 to obtain a corresponding predicted speech recognition hypothesis 244 and corresponding predicted auxiliary-task indications 232. Thereafter, for each particular training sample 420, a loss term module 430 receives the corresponding speech recognition hypothesis 244 and the corresponding predicted auxiliary-task indications 232 output by the ASR model 200 for the particular training sample 420. The loss term module 430 then determines an ASR E2E loss [symbol] _{E2E}^{ASR} 432a for the particular training sample 420 based on differences between the corresponding predicted speech recognition hypothesis 244 and the ground-truth transcription 424. The loss term module 430 also determines an auxiliary E2E loss [symbol] _{E2E}^{Aux} 432b for the particular training sample 420 based on differences between the predicted auxiliary-task indications 232 and the ground-truth auxiliary tokens 426. In particular, each auxiliary-task joint network 230 generates a sequence prediction Y_{Aux} 232 based on the predicted ASR sequence Y_{ASR} 244. Thus, each auxiliary-task joint network 230 predicts P_{E2E}(Y_{Aux}|Ŷ_{ASR}; X) to produce the auxiliary E2E loss [symbol] _{E2E}^{Aux} 432b.

In the second training phase 400b of the training process 400 shown in FIG. 4B, the ASR model 200 is trained using an unpaired training data set 435 that includes a second set of training samples 440, 440a-n. Each training sample 440 in the second set of training samples 440 includes a textual utterance 442 that is not paired with any corresponding audio data. Here, each textual utterance 442 is annotated with the ground-truth auxiliary tokens 444 associated with one or more auxiliary tasks performed by the ASR model 200d. In some examples, the ground-truth auxiliary-tokens 444 are inserted, for example, based on a set of heuristic-based rules and exceptions applied to the corresponding textual utterance 442. Alternatively, the ground-truth tokens 444 may be determined via distillation from a language model teacher that receives the corresponding textual utterances 442 as input and injects the ground-truth auxiliary tokens 444 into the corresponding textual utterance 442. Alternatively, when the textual utterances 442 are taken from short-query losses, an <eos> token is simply appended to the end of each textual utterance 442. However, the ground-truth auxiliary tokens 444 labels may be inserted using other methods, such as manually during manual transcription.

For each particular training sample 440 in the set of training samples 440, the second training phase 400b processes, using the ASR model 200, the corresponding textual utterance 442 to obtain a corresponding predicted speech recognition hypothesis 244 and corresponding predicted auxiliary-task indications 232. Notably, the second training phase 400b performs training using text injection. Here, the ASR model is operated in an internal LM (ILM) mode and the textual utterance 442 (rather the outputs 252 of the Softmax layer 250) is injected or fed into the prediction network 300, and acoustic frames 448 containing zeroes are fed into the encoder 210. Thereafter, for each particular training sample 440, the loss term module 430 receives the corresponding predicted speech recognition hypothesis 244 and the corresponding predicted auxiliary-task indications 232 output by the ASR model 200 for the particular training sample 440. The loss term module 430 then determines an ASR ILM loss, [symbol] _{ILM}^{ASR} 432c for the particular training sample 440 based on differences between the corresponding predicted speech recognition hypothesis 244 and the textual utterance 442. The loss term module 430 also determines an auxiliary ILM loss [symbol] _{ILM}^{Aux} 432d for the particular training sample 440 based on differences between the predicted auxiliary-task indications 232 and the ground-truth auxiliary tokens 444.

In particular, because acoustic frames 110 do not exist for the second training phase 400b, the second training phase 400b ignores the blank posterior, and the predicted next token probabilities are given directly by the Softmax output in Equation (4). A probability P_{ILM}(yₜ: y_{0:t-1}) may be determined based on the textual utterance 442 (i.e., a previous token history 442) as input and next token probabilities as output. Here, the Text ASR ILM loss [symbol] _{ILM}^{ASR} 432c is defined as the negative log probability of each label token given the label sequence prefix, which may be expressed as:

$${ℒ}_{ILM}^{A S R} = - {\sum }_{u = 1}^{U} log P ( {y}_{u}^{A S R} \vert {\hat{y}}_{0 : u - 1}^{A S R} ) . \qquad ( 8 )$$

The training process 400 then trains the ASR model 200 based on the losses 432 determined by the first training phase 400a and the second training phase 400b. Here, the training process 400 adjusts, adapts, updates, fine-tunes, etc. one or more parameters of the encoder 210 and the decoder 220 (i.e., weights of the weight matrices P, Q, and A of Equation (1)). In some examples, the ASR E2E losses [symbol] _{E2E}^{ASR} 432a are averaged over the first data set [symbol] _{paired} 415, the ASR ILM losses [symbol] _{ILM}^{ASR} 432c are averaged over the second data set [symbol] _{unpaired} 435, and then the averaged losses are combined in a weighted average to obtain a total ASR JEIT loss, which may be expressed as:

$${ℒ}_{{JEIT}^{}}^{ASR} ( {paired}_{} , {unpaired}_{} ) = {L}_{E 2 E}^{ASR} ( {paired}_{} ) + {βℒ}_{ILM}^{ASR} ( {unpaired}_{} ) , \qquad ( 9 )$$

where β is a hyperparameter that controls the relative weight given to ILM training as compared to E2E training. In some examples, β=0.2.

The Auxiliary ILM loss [symbol] _{ILM}^{Aux} 432d may be similarly defined as:

$${ℒ}_{ILM}^{A u x} = - {\sum }_{u = 1}^{U} log P ( {y}_{u}^{A u x} \vert {\hat{y}}_{0 : u - 1}^{ASR} ) . \qquad ( 10 )$$

A total auxiliary JEIT loss may be similarly computed using Equation (9).

An example full JEIT loss [symbol] _{ILM}^{Total} that the training process 400 uses to train the ASR model 200 is a linear combination of the losses for all tasks and data sets. Assuming capitalization and pause auxiliary tasks are implemented, the full JEIT loss [symbol] _{ILM}^{Total} may be expressed as:

$${ℒ}_{JEIT}^{t o t a l} = {ℒ}_{E 2 E}^{ASR} + {βℒ}_{ILM}^{ASR} + {α}_{C a p} ( {ℒ}_{E 2 E}^{Cap} + {βℒ}_{ILM}^{Cap} ) + {α}_{Pause} ( {ℒ}_{E 2 E}^{Pause} + {βℒ}_{ILM}^{Pause} ) , \qquad ( 11 )$$

where α_{cap} and αₚₐᵤₛₑ are hyperparameters that control the relative weight given to the capitalization and pause auxiliary tasks. In some examples, α_{cap}=0.1, and α_{Pause}=0.3.

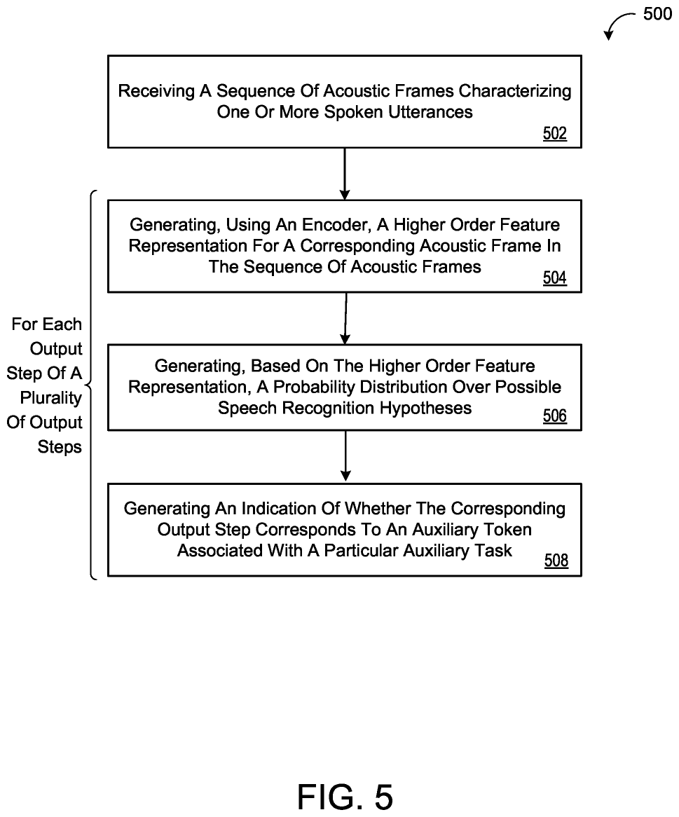

FIG. 5 is a flowchart of an exemplary arrangement of operations for a computer-implemented method 500 for training a joint auxiliary task and ASR model (e.g., the ASR model 200). The operations may be performed by data processing hardware 510 (e.g., the data processing hardware 12 of the user device 10 or the data processing hardware 52 of the remote computing system 60) based on executing instructions stored on memory hardware 520 (FIG. 5) (e.g., the memory hardware 14 of the user device 10 or the memory hardware 54 of the remote computing system 60).

At operation 502, the method 500 includes receiving a sequence of acoustic frames 110 characterizing one or more spoken utterances. The method 500 includes at operation 504 generating, at each of a plurality of output steps, a higher-order feature representation 212 for a corresponding acoustic frame 110 in the sequence of acoustic frames 110. At operation 506, the method 500 includes generating, at each of the plurality of output steps, a probability distribution over possible speech recognition hypotheses 242. The method 500 at operation 508 includes generating, at each of the plurality of output steps, an indication 232 of whether the corresponding output step corresponds to an auxiliary token associated with a particular auxiliary task. Here, the joint auxiliary task and ASR model is trained by a JEIT training process 400 based on: a paired training data set 415 that includes a first set of training samples 420, each training sample 420 in the first set of training samples 420 including audio data 422 characterizing an utterance of speech paired with a corresponding transcription 424 of the utterance, the corresponding transcription 424 annotated with ground-truth auxiliary tokens 426 associated with the particular auxiliary task; and an unpaired training data set 435 including a second set of training samples 440, each training sample 440 in the second set of training samples 440 including a textual utterance 442 not paired with any corresponding audio data, the textual utterance 442 annotated with the ground-truth auxiliary tokens 444 associated with the particular auxiliary task.

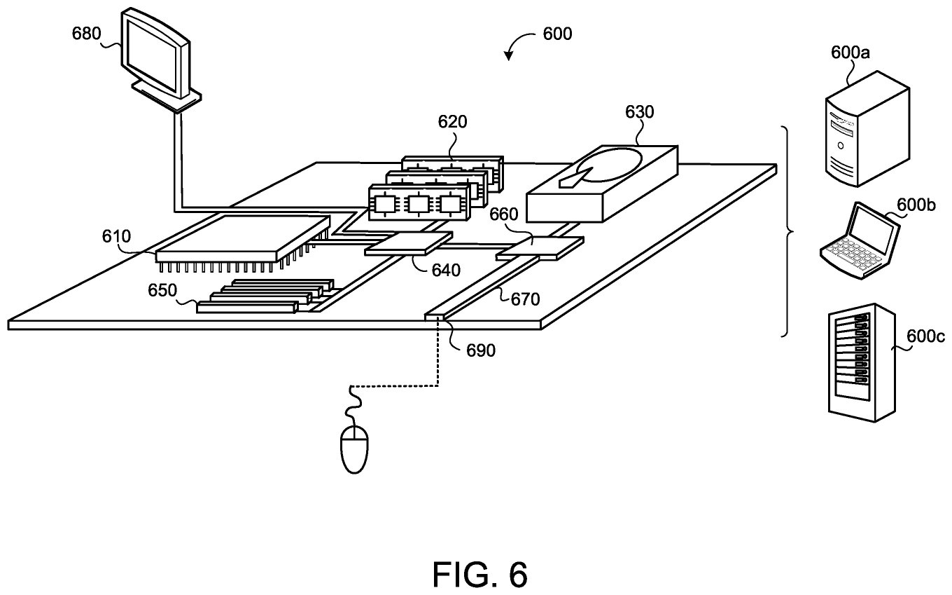

FIG. 6 is schematic view of an example computing device 600 that may be used to implement the systems and methods described in this document. The computing device 600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 600 includes a processor 610 (i.e., data processing hardware) that can be used to implement the data processing hardware 12 and/or 62, memory 620 (i.e., memory hardware) that can be used to implement the memory hardware 14 and/or 64, a storage device 630 (i.e., memory hardware) that can be used to implement the memory hardware 14 and/or 64, a high-speed interface/controller 640 connecting to the memory 620 and high-speed expansion ports 650, and a low speed interface/controller 660 connecting to a low speed bus 670 and a storage device 630. Each of the components 610, 620, 630, 640, 650, and 660, are interconnected using various busses, and may be mounted on a common motherboard or in other manners as appropriate. The processor 610 can process instructions for execution within the computing device 600, including instructions stored in the memory 620 or on the storage device 630 to display graphical information for a graphical user interface (GUI) on an external input/output device, such as display 680 coupled to high speed interface 640. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 620 stores information non-transitorily within the computing device 600. The memory 620 may be a computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 630 is capable of providing mass storage for the computing device 600. In some implementations, the storage device 630 is a computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 620, the storage device 630, or memory on processor 610.

The high speed controller 640 manages bandwidth-intensive operations for the computing device 600, while the low speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port 690. The low-speed expansion port 690, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, “or” refers to an inclusive or and not to an exclusive or. For example, “A, B, or C” refers to any combination or subset of A, B, C such as: (1) A alone; (2) B alone; (3) C alone; (4) A with B; (5) A with C; (6) B with C; and (7) A with B and with C. Similarly, the phrase “at least one of A or B” is intended to refer to any combination or subset of A and B such as: (1) at least one A; (2) at least one B; and (3) at least one A and at least one B. Moreover, the phrase “at least one of A and B” is intended to refer to any combination or subset of A and B such as: (1) at least one A; (2) at least one B; and (3) at least one A and at least one B.

A number of implementations have been described. Nevertheless, it will be understood that various modifications may be made without departing from the spirit and scope of the disclosure. Accordingly, other implementations are within the scope of the following claims.

What is claimed is:

1. A joint auxiliary task and automated speech recognition (ASR) model comprising:
an encoder configured to:
receive, as input, a sequence of acoustic frames characterizing one or more utterances; and
generate, at each output step of a plurality of output steps, a higher-order feature representation for a corresponding acoustic frame in the sequence of acoustic frames; and
a multi-output hybrid autoregressive transducer (HAT) decoder configured to:
receive, as input, a sequence of non-blank symbols output by a final Softmax layer;
receive, as input, the higher-order feature representation generated by the encoder at each output step of the plurality of output steps; and
generate, at each output step of the plurality of output steps:
a probability distribution over possible speech recognition hypotheses; and
an indication of whether the output step corresponds to an auxiliary token associated with a particular auxiliary task,
wherein the joint auxiliary task and ASR model is trained by a joint end-to-end model and internal language model training process based on:
a paired training data set comprising a first set of training samples, each training sample in the first set of training samples comprising audio data characterizing an utterance of speech paired with a corresponding transcription of the utterance, the corresponding transcription annotated with ground-truth auxiliary tokens associated with the particular auxiliary task; and
an unpaired training data set comprising a second set of training samples, each training sample in the second set of training samples comprising a textual utterance not paired with any corresponding audio data, the textual utterance annotated with the ground-truth auxiliary tokens associated with the particular auxiliary task.

2. The joint auxiliary task and ASR model of claim 1, wherein one or more of the corresponding transcriptions in the paired training data set are annotated with the ground-truth auxiliary tokens automatically based on a set of heuristic-based rules and exceptions applied to the corresponding transcriptions and corresponding portions of the paired audio data.

3. The joint auxiliary task and ASR model of claim 1, wherein one or more of the corresponding transcriptions in the paired training data set are annotated with the ground-truth auxiliary tokens via distillation from a language model teacher that receives the corresponding transcriptions as input and injects the ground-truth auxiliary tokens into the corresponding transcriptions.

4. The joint auxiliary task and ASR model of claim 1, wherein one or more of the textual utterances in the unpaired training data set are annotated with the ground-truth auxiliary tokens via distillation from a language model teacher that receives the textual utterances as input and injects the ground-truth auxiliary tokens into the textual utterances.

5. The joint auxiliary task and ASR model of claim 1, wherein:
one or more of the textual utterances in the unpaired training data set each comprise text characterizing a short query; and
each textual utterance of the one or more of the textual utterances in the unpaired training data set that comprises text characterizing a short query are annotated with the ground-truth auxiliary tokens by appending a first type of ground-truth auxiliary token at an end of the textual utterance.

6. The joint auxiliary task and ASR model of claim 1, wherein the multi-output HAT decoder comprises:
a prediction network configured to, at each output step of the plurality of output steps:
receive, as input, the sequence of non-blank symbols output by a final Softmax layer; and
generate a hidden representation;
a first joint network configured to:
receive, as input, the hidden representation generated by the prediction network at each output step of the plurality of output steps and the higher-order feature representation generated by the encoder at each output step of the plurality of output steps; and
generate, at each output step of the plurality of output steps, the probability distribution over possible speech recognition hypotheses; and
a second joint network configured to:
receive, as input, the hidden representation generated by the prediction network at each output step of the plurality of output steps and the higher-order feature representation generated by the encoder at each output step of the plurality of output steps; and
generate, at each output step of the plurality of output steps, the indication of whether the output step corresponds to the auxiliary token.

7. The joint auxiliary task and ASR model of claim 6, wherein, at each output step of the plurality of output steps:
the sequence of previous non-blank symbols received as input at the prediction network comprises a sequence of N previous non-blank symbols output by the final Softmax layer; and
the prediction network is configured to generate the hidden representation by:
for each non-blank symbol of the sequence of N previous non-blank symbols, generating a respective embedding; and
generating an average embedding by averaging the respective embeddings, the average embedding comprising the hidden representation.

8. The joint auxiliary task and ASR model of claim 6, wherein:
the auxiliary token comprises a first type of auxiliary token; and
the multi-output HAT decoder further comprises a third joint network configured to:
receive, as input, the hidden representation generated by the prediction network at each output step of the plurality of output steps and the higher-order feature representation generated by the encoder at each output step of the plurality of output steps; and
generate, at each output step of the plurality of output steps, another indication of whether the output step corresponds to a second type of auxiliary token associated with a second auxiliary task that is different from the particular auxiliary task.

9. The joint auxiliary task and ASR model of claim 1, wherein the auxiliary token associated with the particular auxiliary task comprises one of:
a pause token associated with the particular auxiliary task of pause prediction;
an end of speech token associated with the particular auxiliary task of pause prediction; or
a capitalization token associated with the particular auxiliary task of punctuation.

10. The joint auxiliary task and ASR model of claim 9, wherein:
the auxiliary token comprises a first type of auxiliary token associated with the particular auxiliary task;
the multi-output HAT decoder is further configured to generate, at each output step of the plurality of output steps, another indication of whether the output steps corresponds to a second type of auxiliary token associated with a second auxiliary task that is different from the particular auxiliary task; and
the second type of auxiliary token associated with the second auxiliary task comprises a different one of:
the pause token;
the end of speech token; or
the capitalization token.

11. A computer-implemented method executed on data processing hardware that causes the data processing hardware to perform operations comprising:
receiving a sequence of acoustic frames characterizing one or more utterances;
at each of a plurality of output steps:
generating, by an encoder of a joint auxiliary task and automated speech recognition (ASR) model, a higher-order feature representation for a corresponding acoustic frame in the sequence of acoustic frames; and
generating, by a multi-output hybrid autoregressive transducer (HAT) decoder of the joint auxiliary task and ASR model, based on the higher-order feature representation generated by the encoder at the corresponding output step and a sequence of non-blank symbols output by a final Softmax layer:
a probability distribution over possible speech recognition hypotheses; and
an indication of whether the output step corresponds to an auxiliary token associated with a particular auxiliary task,
wherein the joint auxiliary task and ASR model is trained by a joint end-to-end model and internal language model training process based on:
a paired training data set comprising a first set of training samples, each training sample in the first set of training samples comprising audio data characterizing an utterance of speech paired with a corresponding transcription of the utterance, the corresponding transcription annotated with ground-truth auxiliary tokens associated with the particular auxiliary task; and
an unpaired training data set comprising a second set of training samples, each training sample in the second set of training samples comprising a textual utterance not paired with any corresponding audio data, the textual utterance annotated with the ground-truth auxiliary tokens associated with the particular auxiliary task.

12. The computer-implemented method of claim 11, wherein one or more of the corresponding transcriptions in the paired training data set are annotated with the ground-truth auxiliary tokens automatically based on a set of heuristic-based rules and exceptions applied to the corresponding transcriptions and corresponding portions of the paired audio data.

13. The computer-implemented method of claim 11, wherein one or more of the corresponding transcriptions in the paired training data set are annotated with the ground-truth auxiliary tokens via distillation from a language model teacher that receives the corresponding transcriptions as input and injects the ground-truth auxiliary tokens into the corresponding transcriptions.

14. The computer-implemented method of claim 11, wherein one or more of the textual utterances in the unpaired training data set are annotated with the ground-truth auxiliary tokens via distillation from a language model teacher that receives the textual utterances as input and injects the ground-truth auxiliary tokens into the textual utterances.

15. The computer-implemented method of claim 11, wherein:
one or more of the textual utterances in the unpaired training data set each comprise text characterizing a short query; and
each textual utterance of the one or more of the textual utterances in the unpaired training data set that comprises text characterizing a short query are annotated with the ground-truth auxiliary tokens by appending a first type of ground-truth auxiliary token at an end of the textual utterance.

16. The computer-implemented method of claim 11, wherein the multi-output HAT decoder comprises:
a prediction network configured to, at each output step of the plurality of output steps:
receive, as input, the sequence of non-blank symbols output by a final Softmax layer; and
generate a hidden representation;
a first joint network configured to:
receive, as input, the hidden representation generated by the prediction network at each output step of the plurality of output steps and the higher-order feature representation generated by the encoder at each output step of the plurality of output steps; and
generate, at each output step of the plurality of output steps, the probability distribution over possible speech recognition hypotheses; and
a second joint network configured to:
receive, as input, the hidden representation generated by the prediction network at each output step of the plurality of output steps and the higher-order feature representation generated by the encoder at each output step of the plurality of output steps; and
generate, at each output step of the plurality of output steps, the indication of whether the output step corresponds to the auxiliary token.

17. The computer-implemented method of claim 16, wherein, at each output step of the plurality of output steps:
the sequence of previous non-blank symbols received as input at the prediction network comprises a sequence of N previous non-blank symbols output by the final Softmax layer; and
the prediction network is configured to generate the hidden representation by:
for each non-blank symbol of the sequence of N previous non-blank symbols, generating a respective embedding; and
generating an average embedding by averaging the respective embeddings, the average embedding comprising the hidden representation.

18. The computer-implemented method of claim 16, wherein:
the auxiliary token comprises a first type of auxiliary token; and
the multi-output HAT decoder further comprises a third joint network configured to:
receive, as input, the hidden representation generated by the prediction network at each output step of the plurality of output steps and the higher-order feature representation generated by the encoder at each output step of the plurality of output steps; and
generate, at each output step of the plurality of output steps, another indication of whether the output step corresponds to a second type of auxiliary token associated with a second auxiliary task that is different from the particular auxiliary task.

19. The computer-implemented method of claim 11, wherein the auxiliary token associated with the particular auxiliary task comprises one of:
a pause token associated with the particular auxiliary task of pause prediction;
an end of speech token associated with the particular auxiliary task of pause prediction; or
a capitalization token associated with the particular auxiliary task of punctuation.

20. The computer-implemented method of claim 11, wherein:
the auxiliary token comprises a first type of auxiliary token associated with the particular auxiliary task;
the multi-output HAT decoder is further configured to generate, at each output step of the plurality of output steps, another indication of whether the output steps corresponds to a second type of auxiliary token associated with a second auxiliary task that is different from the particular auxiliary task; and
the second type of auxiliary token associated with the second auxiliary task comprises a different one of:
the pause token;
the end of speech token; or
the capitalization token.
